(19) United States
(12) Patent Application Publication
(10) Pub. No.: US 2025/0194478 A1
(43) Pub. Date: Jun. 19, 2025

(54) MOUNTED FERTIGATION DEVICE AND METHOD

(71) Applicant: PIONEER HI-BRED INTERNATIONAL, INC., JOHNSTON, IA (US)

(72) Inventors: JUSTIN P GIBSON, URBANDALE, IA (US); DAVID B MYERS, JOHNSTON, IA (US); CHRISTOPHER K PARRY, JOHNSTON, IA (US); KEVIN P TU, JOHNSTON, IA (US); GERARDUS W. A. M. VAN DER HEIJDEN, GRIMES, IA (US)

(73) Assignee: PIONEER HI-BRED INTERNATIONAL, INC., JOHNSTON, IA (US)

(21) Appl. No.: 18/711,051

(22) PCT Filed: Nov. 15, 2022
(86) PCT No.: PCT/US2022/079905

§ 371 Date: May 16, 2024

Related U.S. Application Data
(60) Provisional application No. 63/287,997, filed on Dec. 10, 2021.

(51) Int. Cl. A01G 25/09; A01C 21/00; A01C 23/04; G01N 21/84

(52) U.S. Cl. CPC A01G 25/09; A01C 21/007; A01C 23/042; A01C 23/047; G01N 21/84; G01N 2021/8466

(57) ABSTRACT

A system for automatically determining a fertigation timing or amount in real time based on a plant canopy measurement is provided. The system includes a fertigation device for applying fluid to the plant canopy. A sensor is coupled to the fertigation device and configured to measure a condition of the plant canopy. Control circuitry is configured to control the system.

### BACKGROUND

The present disclosure relates to a fertigation system, and more particularly, to a fertigation system for automatically determining a fertigation timing or amount in real time based on a plant canopy measurement.

In semi-arid environments crops often have crop water requirements (evapotranspiration; ET) that exceed water supplied from rainfall. To ensure a crop develops and produces at its potential rate, water needs to be applied to the soil though irrigation to make up for any water needs not met by rainfall. Optimal crop water management accounts for ET to ensure that the right amount of irrigation is applied to meet and not overly exceed ET. In addition to water, crops often need fertilizer to be applied to the soil to meet nutrient demands in order to sustain growth. Irrigation systems can often distribute both water and fertilizer (or other agro-chemicals) when solutes are mixed in solution with water flowing through the irrigation system. Center pivot irrigation is a common irrigation system in the United States western Cornbelt. Center pivots apply irrigation to a field via an approximately 400 m steel lateral that is mounted to towers that move through a field on electric motors driving wheels. In this case, irrigation and fertigation application can be determined based on tracking the pivot location over time. Using the approach of tracking ET and applied irrigation and/or fertilizers, optimized recommendations for application can be generated.

### SUMMARY

The present disclosure includes one or more of the features recited in the appended claims and/or the following features which, alone or in any combination, may comprise patentable subject matter.

According to a first aspect of the disclosed embodiments, a system for automatically determining a fertigation timing or amount in real time based on a plant canopy measurement is provided. The system includes a fertigation device for applying fluid to the plant canopy. A sensor is coupled to the fertigation device and configured to measure a condition of the plant canopy. Control circuitry having a processor and a memory is provided. The memory is embedded with instructions configured to be executed by the processor. The control circuitry is in communication with the sensor and the processor is configured to map the condition of the plant canopy.

In some embodiments of the first aspect, the fluid may include at least one of water and water in combination with agro-chemicals. The control circuitry may be operably linked to a regulator that regulates the flow of the at least one of water and water in combination with agro-chemicals. The fluid may include agro-chemicals added to the system through a fertigation control system that is adjusted by the control circuitry in real time. The fertigation control system may include at least one of a venturi system, a suction injection system, an electric injection pump, a piston-activated pump and a diaphragm activated pump. The agro-chemical may be a fertilizer and may include at least one of nitrogen, phosphorous, and potassium. The agro-chemical may be a pesticide and may include at least one of insecticides, herbicides, fungicides, bactericides, and nematicides.

Optionally, in the first aspect, the control circuitry may include a remote computing device. The control circuitry may be positioned on the fertigation device and may be coupled to the sensor. A measurement of the nitrogen level of the plant canopy may be determined based on a measurement of the sensor. A measurement of the net radiation of the plant canopy may be determined based on a measurement of the sensor. The flow rate of the fertigation applied to the plant canopy may be determined based on the net radiation of the plant canopy. In addition to an infrared radiometer, the sensor may also include a net radiometer.

It may be desired, in the first aspect, that the processor is configured to calculate a sensible heat flux from the plant canopy. The processor may be configured to receive data related to a soil heat flux of the plant canopy. The processor may be configured to calculate a latent heat flux of the plant canopy based on the net radiation, the sensible heat flux, and the soil heat flux. A flow rate of the fluid applied to the plant canopy may be adjusted based on the latent heat flux of the plant canopy. The processor may be configured to calculate the net radiation of the plant canopy by adding a net shortwave radiation to a net longwave radiation. The processor may be configured to calculate the net shortwave radiation by subtracting a reflected solar radiation from an incoming shortwave radiation detected by the sensor. The reflected solar radiation may be estimated by multiplying an albedo by the incoming shortwave radiation detected by the sensor. The processor may be configured to calculate the net longwave radiation by subtracting an outgoing longwave radiation from an incoming longwave radiation. The outgoing longwave radiation may be calculated by multiplying an emissivity of the plant canopy, the Stefan-Boltzmann constant, and a temperature of the plant canopy as measured by the sensor to the fourth power. The incoming longwave radiation may be calculated by multiplying an emissivity of the air, the Stefan-Boltzmann constant, and a temperature of the air to the fourth power. The albedo may be calculated based on at least one of a solar zenith angle, a location, and an aerial image. The processor may be configured to calculate the sensible heat flux from the plant canopy by characterizing a surface temperature ramp structure including a ramp amplitude and a ramp duration measured by the sensor using the Van Atta Analysis procedure. The processor may be configured to receive the data related to the soil heat flux of the plant canopy from a weather station.

It may be contemplated, in the first aspect, that the sensor may be at least one of a radiation sensor, a temperature sensor, a relative humidity sensor, a rain gauge, a nitrogen sensor, a spectral sensor, an accelerometer, an anemometer, a global positioning sensor, and a pressure sensor. The fertigation device may be at least one of a linear irrigator and a center pivot irrigator. The sensor may be an infrared radiation measurement device. The infrared radiation measurement device may be at least one of a net radiometer, a pyrgeometer, and an infared radiometric thermometer. The sensor may include a forward facing sensor that measures radiation from an un-watered portion of the plant canopy. A rear facing sensor may measure radiation from a watered portion of the plant canopy.

In some embodiments of the first aspect, the processor may determine a speed of the fertigation device. The processor may adjust a flow rate of the fertigation device based on the speed of the fertigation device and the condition of the plant canopy. A positioning sensor may be coupled to the fertigation device and may be configured to detect a position of the fertigation device. The processor may determine the speed of the fertigation device based on a rate of change in a position of the fertigation device over time. A fertigation application depth may be determined based on the speed of the fertigation device and fertigation device parameters.

Optionally, in the first aspect, the sensor may include at least two radiometers configured to obtain simultaneous forward and rear facing measurements of the plant canopy. The radiometers may be infrared radiometers that compute a canopy temperature by detecting plant canopy radiation. Net radiometers that measure the energy balance between incoming short wave and long wave infrared radiation may also be used. The at least two infrared radiometers may be positioned on at least one adjustable mount that is adjustable by remote control. A pair of mounts may be provided. The at least two infrared radiometers may each be positioned on one of the pair of mounts. Each of the pair of mounts may be independently adjustable. The at least one adjustable mount may be operable through a graphical user interface. The at least two infrared radiometers may each measure a plant canopy radiation. Each plant canopy radiation measurement may be used to calculate at least one of a rate and amount of evapotranspiration of the plant canopy. The at least one of a rate and amount of evapotranspiration may be used to at least one of schedule an application of fertigation and control a speed of the fertigation device. A second sensor may measure incoming radiation.

The one or more infrared radiometers may be mounted on an irrigation device, so that the field of view of each infrared radiometer comprises an oval or ellipse shaped single ‘pixel’ of the plant canopy and soil (if exposed in the radiometer's field of view) that is interrogated by the radiometer. This curved pixel is distinguishable from the rectangular or square pixel commonly created from an imaging device such as a thermal camera. This simplifies the calculation of evapotranspiration and enables real time adjustments to the effect of fertigation.

In some embodiments, the radiometer measures radiation at varying level in the canopy, from the leaves at the top of the canopy to the soil if visible, inclusive of visible leaves in between the soil and the uppermost portion of the plant canopy. In some embodiments, the soil will not be visible, and the radiometer will measure leaves at varying levels within the plant canopy. The infrared radiometer may also be referred to as an infrared thermometer, because even though radiation is detected, temperature is the quantity measured. In some embodiments, the infrared radiometer may measure radiation between 6.5 to 14 microns in order to minimize the atmospheric effect of humidity or water vapor between the infrared radiometer and the plant canopy.

In some embodiments, the radiometer may be a net radiometer which measure both incoming and outgoing short and long wave radiation. In this case, the net radiation may be used directly in the energy balance model (net radiation=evapotranspiration+sensible heat flux+soil heat flux). Where soil is visible, the infrared radiometer can determine soil temperature and heat flux. Where soil is not visible, the soil temperature and heat flux may be modeled. Accordingly, there may be advantages to using infrared radiometers mounted on the pivot or other irrigation device in combination with data from a net radiometer, which may provide data to several pivots or other irrigation devices in proximity with each other.

According to a second aspect of the disclosed embodiments, a method for recommending fertigation timing and amount for a plant canopy may include determining a net radiation of the plant canopy. The method also includes calculating a sensible heat flux from the plant canopy based on the net radiation. The method also includes receiving data related to a soil heat flux of the plant canopy. The method also includes calculating a latent heat flux of the plant canopy based on the net radiation, the sensible heat flux, and the soil heat flux.

In some embodiments of the second aspect, the method may also include measuring radiation from an unwatered portion of the plant canopy with a forward-facing sensor. the method may also include measuring radiation from a watered portion of the plant canopy with a rear facing sensor. The method may also include calculating the net radiation from the plant canopy by adding a net shortwave radiation to a net longwave radiation. The method may also include estimating a reflected solar radiation by multiplying an albedo by the incoming shortwave radiation detecting by the sensor. The method may also include calculating the net shortwave radiation by subtracting a reflected solar radiation from an incoming shortwave radiation detecting by the sensor. The method may also include calculating an outgoing longwave radiation by multiplying an emissivity of the plant canopy, the Stefan-Boltzmann constant, and a temperature of the plant canopy as measured by the sensor to the fourth power. The method may also include calculating an incoming longwave radiation by multiplying an emissivity of the air, the Stefan-Boltzmann constant, and a temperature of the air to the fourth power. The method may also include calculating the net longwave radiation by subtracting the outgoing longwave radiation from the incoming longwave radiation. The method may also include calculating the sensible heat flux from the plant canopy by characterizing a surface temperature ramp structure including a ramp amplitude and a ramp duration measured by the sensor using the Van Atta Analysis procedure. The method may also include receiving the data related to the soil heat flux of the plant canopy from a weather station.

Optionally, in the second aspect, the method may also include determining a speed of a fertigation device applying water to the plant canopy. The method may also include adjusting a flow rate of the fertigation device based on the speed of the fertigation device and the latent heat flux of the plant canopy. The method may also include detecting a position of the fertigation device with a position sensor. The method may also include determining the speed of the fertigation device based on a rate of change in a position of the fertigation device over time.

According to a third aspect of the disclosed embodiments, a fertigation device includes at least two infrared radiometers configured to obtain simultaneous forward and rear facing measurements of a plant canopy.

In some embodiments of the third aspect, the at least two infrared radiometers may be positioned on at least one adjustable mount that is adjustable by remote control. A pair of mounts may be provided. The at least two infrared radiometers may each be positioned on one of the pair of mounts. Each of the pair of mounts may be independently adjustable. The at least one adjustable mount may be operable through a graphical user interface. The at least two infrared radiometers may each measure a plant canopy radiation. Each plant canopy radiation measurement may be used to calculate at least one of a rate and amount of evapotranspiration of the plant canopy. The at least one of a rate and amount of evapotranspiration may be used to at least one of schedule an application of fertigation and control a speed of the fertigation device. The fertigation device may include a pivot.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION

The detailed description particularly refers to the accompanying figures in which:

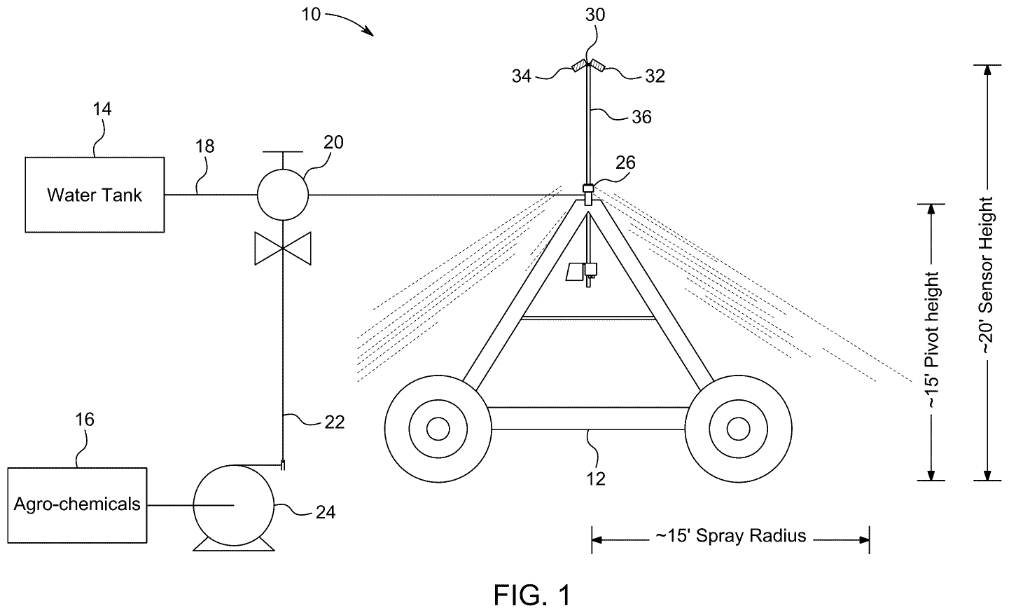

FIG. 1 is a schematic view of a system for automatically determining a fertigation timing or amount in real time based on a plant canopy measurement, wherein the system includes a fertigation device coupled to a source of water and a source of agro-chemicals;

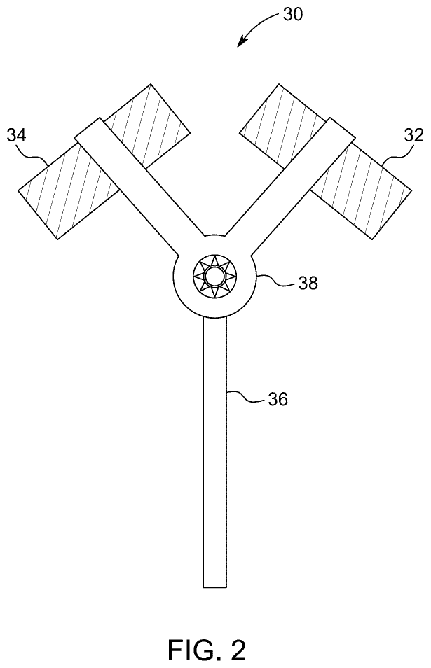

FIG. 2 is an expanded view of the forward facing sensor and the rear facing sensor shown in FIG. 1;

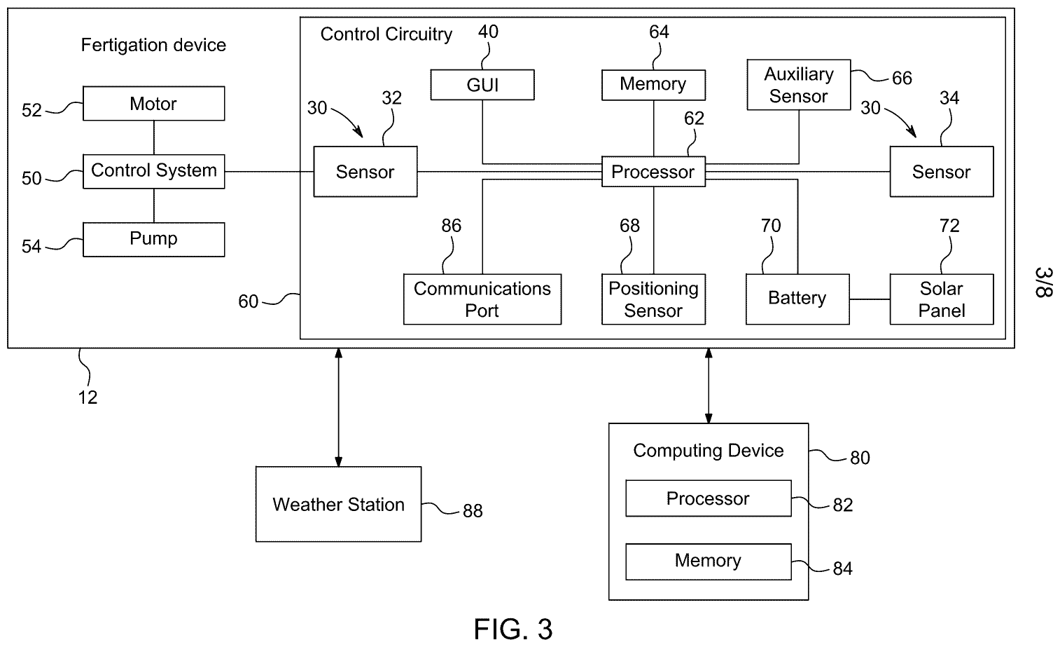

FIG. 3 is a schematic view of control circuitry for the system of FIG. 1 in communication with a computing device and a weather station;

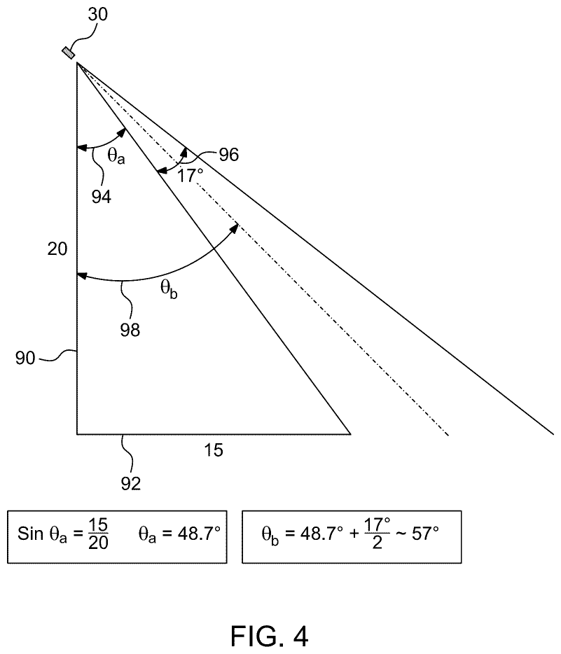

FIG. 4 is a schematic view of a viewing angle of the sensor of FIG. 1;

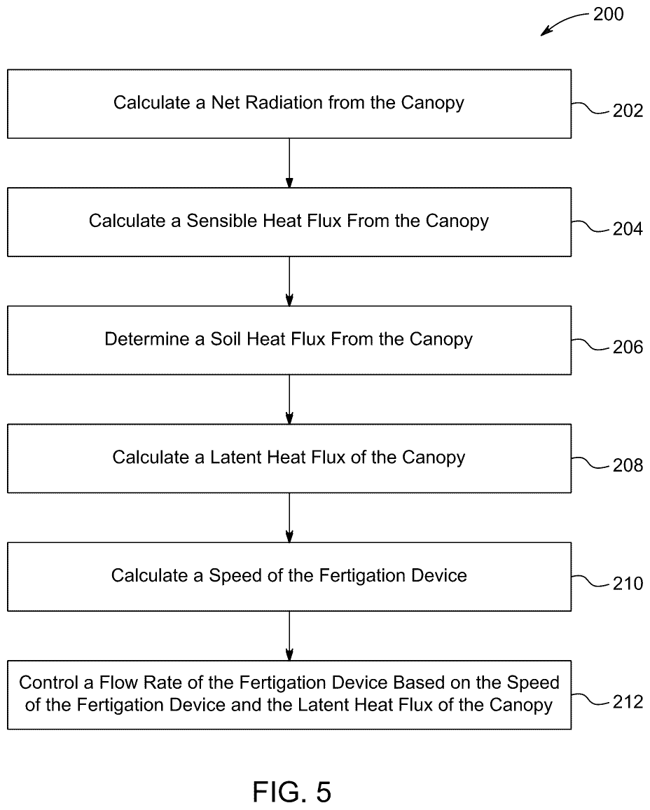

FIG. 5 is a flowchart of a method for controlling a flow rate of the fertigation device of FIG. 1 based on a speed of the fertigation device and a latent heat flux of the plant canopy;

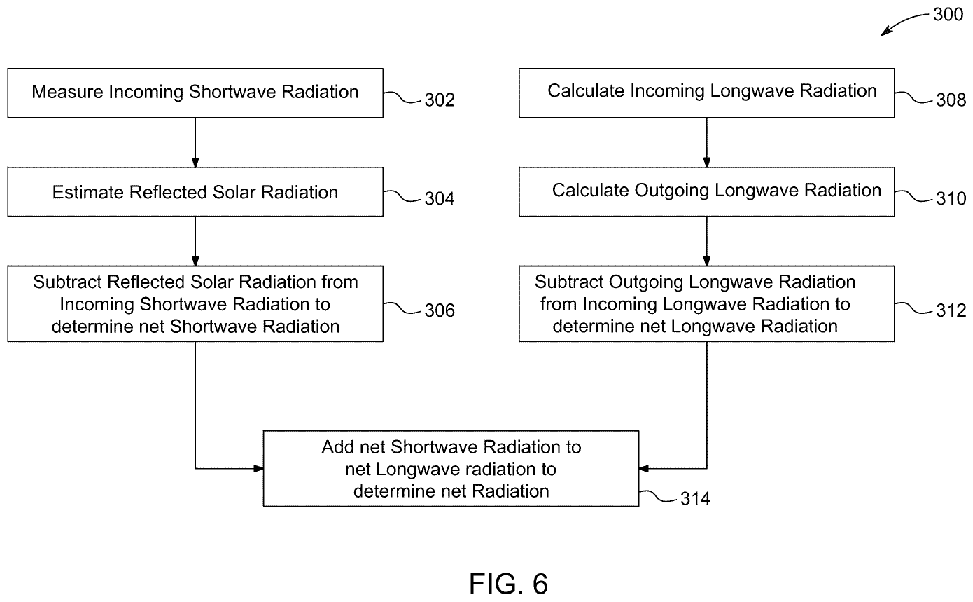

FIG. 6 is a flowchart of a method for determining a net radiation of the plant canopy;

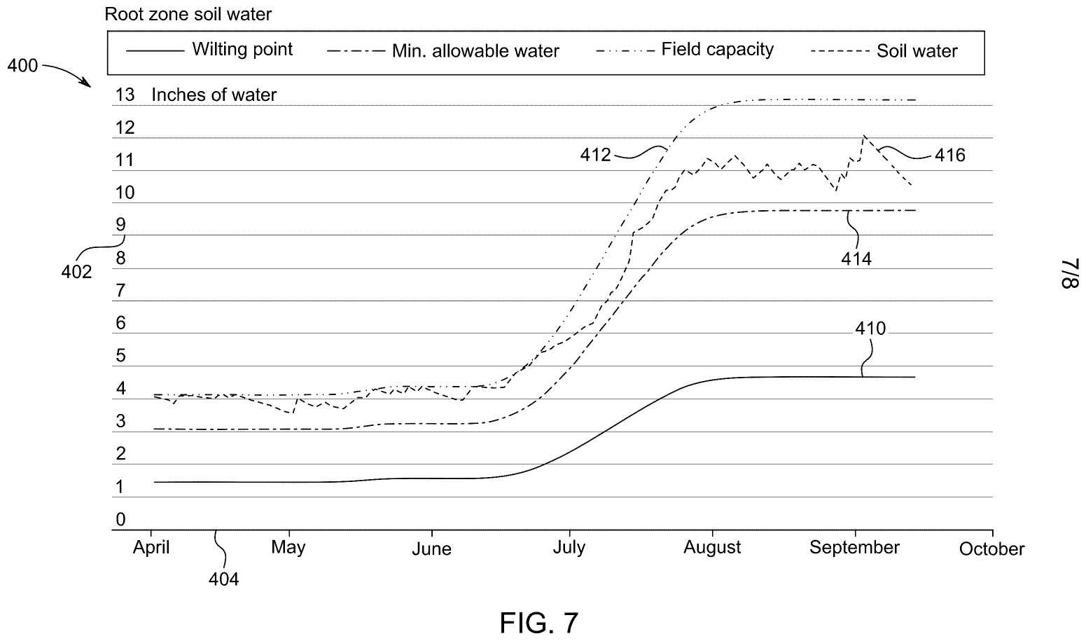

FIG. 7 is a graph showing an amount of fluid application in inches during a year; and

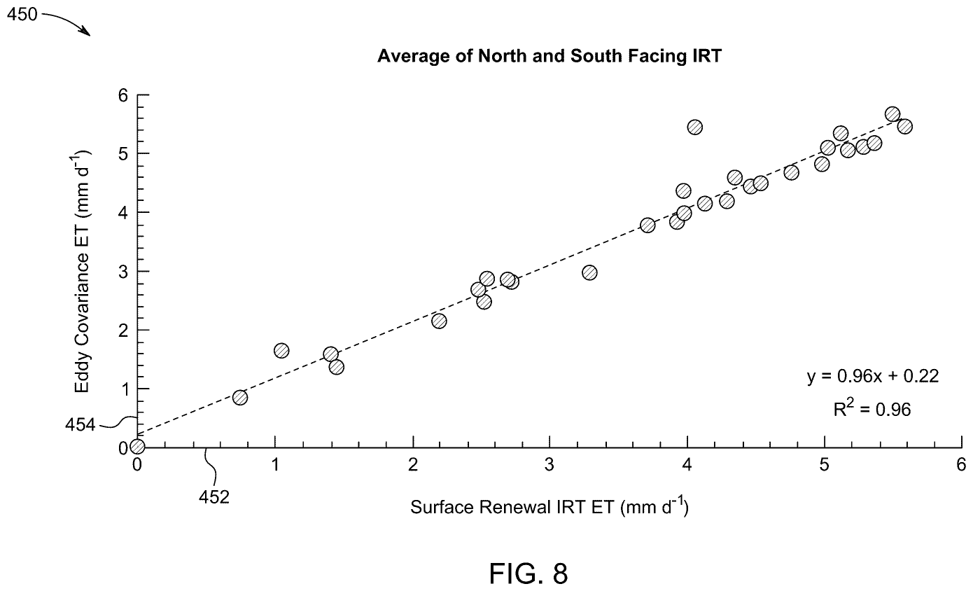

FIG. 8 is a graph showing validation of the evapotranspiration calculated using the sensors of the system of FIG. 1.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

Referring now to FIG. 1 a system 10 is provided for automatically determining a fertigation timing or amount in real time based on a plant canopy measurement. “Fertigation” as used herein refers to irrigation of water alone, as well as, to irrigation of water in combination with agro-chemicals, such as fertilizer or pesticides, each of which have been applied through an irrigation system. Fertilizer may include any or all of nitrogen (commonly in the form of anhydrous ammonia, urea, or ammonium nitrate), phosphorous (commonly in the form of monoammonium phosphate or diammonium phosphate) and potassium (commonly in the form of muriate of potash/potassium chloride), as well as, micro-nutrients, biologicals, adjuvants, chelating agents, or nutrient stabilizers. Pesticides may include insecticides, herbicides, fungicides, bactericides, and nematicides.

The system 10 includes a fertigation device 12 coupled to a source of water 14 and a source of agro-chemicals 16. The fertigation device 12 is configured to apply a fluid to the plant canopy. The fertigation device 12 may be a linear irrigator or a center pivot irrigator. Water is supplied to the fertigation device 12 from the source of water 14 through a fluid passageway 18. In some embodiments, the fertigation device 12 supplies only water to the plant canopy. In other embodiments, a valve 20 is opened to mix agro-chemicals from the source of agro-chemicals 16 with the water. The agro-chemicals are supplied from the source of agro-chemicals 16 to the fluid passageway 18 through a fluid passageway 22. When the valve 20 is opened, the agro-chemicals in the fluid passageway 22 mix with the water in the fluid passageway 18 and are delivered to the fertigation device 12. A pump 24 is configured to pump the agro-chemicals through the fluid passageway 22 and into the fluid passageway 18. The pump 24 may include any one of a venturi system, a suction injection system, an electric injection pump, a piston-activated pump, and/or a diaphragm activated pump. A nozzle 26 is positioned on the fertigation device 12 to dispense fluid onto the plant canopy. For example, the recommended amount of product could be controlled by varying the speed of the lateral or by adjusting the flow rate of an injection system at which the product is mixed into the water. The exact amount of product applied would be adjusted by the control system (item 50). As set forth above, the fluid may include only water or a mixture of water and an agro-chemical.

At least one sensor 30 is coupled to the fertigation device 12. The at least one sensor 30 is configured to measure a condition of the plant canopy. In some embodiments, the at least one sensor 30 is an infrared radiation measurement device, for example, a net radiometer, a pyrgeometer, or an infared radiometric thermometer also referred to as an infrared radiometer or infrared thermometer. The at least one sensor 30 may include a forward facing sensor 32 that measures the condition of an un-watered portion of the plant canopy. The at least one sensor 30 may also include a rear facing sensor 34 that measures the condition of a watered portion of the plant canopy. The forward facing sensor 32 and the rear facing sensor 34 allow data collection in both directions and confirm that fertigation is being applied and measure the effect of application on the plant canopy and/or soil. The forward facing sensor 32 and the rear facing sensor 34 are configured to obtain simultaneous forward and rear facing measurements of the plant canopy. When measuring a net radiation of the plant canopy, each plant canopy radiation measurement from the forward facing sensor 32 and the rear facing sensor 34 is used to calculate a rate and/or amount of evapotranspiration of the plant canopy. The rate and/or the amount of evapotranspiration is used to schedule an application of fertigation and/or control a speed of the fertigation device 12.

The forward facing sensor 32 and the rear facing sensor 34 are each positioned on a mount 36. Each mount 36 may be independently adjustable, for example with a remote control. As illustrated in FIG. 2, the forward facing sensor 32 and the rear facing sensor 34 are coupled to a pivot 38 that enables an angular rotation of the forward facing sensor 32 and the rear facing sensor 34 to be independently adjusted. In some embodiments, each mount 36 is independently adjustable through a graphical user interface (GUI) 40, shown in FIG. 2.

Referring to FIG. 3, the fertigation device 12 includes a control system 50 that controls the operation of the fertigation device 12. The control system 50 is electrically coupled to a motor 52 that controls movement of the fertigation device 12. The control system 50 is also electrically coupled to a pump 54 that controls a flow of the fluid through the nozzle 26. The control system 50 is electrically coupled to control circuitry 60 that includes a processor 62 and a memory 64. The memory 64 is embedded with instructions configured to be executed by the processor 62 so that signals are transmitted to the control system 50 to control the motor 52 and the pump 54. In one embodiment, the control circuitry 60 is in communication with the sensor 30 and the processor 62 is configured to map the condition of the plant canopy based on readings from the sensor 30. As illustrated in FIG. 3, the sensor 30 includes both the forward facing sensor 32 and the rear facing sensor 34.

An auxiliary sensor 66 may be provided in communication with the processor 62 to detect other conditions of the plant canopy. The auxiliary sensor 66 may include a radiation sensor, such as a net radiation sensor, a temperature sensor, a relative humidity sensor, a rain gauge, a nitrogen sensor, a spectral sensor, an accelerometer, an anemometer, and/or a pressure sensor. A global positioning sensor 68 may be provided in communication with the processor 62 to detect a position of the fertigation device 12. Data related to the position of the fertigation device 12 over time may be used by the processor 62 to determine a speed of the fertigation device 12. A battery 70 is provided to power control circuitry 60. In some embodiments, the battery 70 may be charged by a solar panel 72. Additionally, the GUI 40 is electrically coupled to the control circuitry 60. In some embodiments, the GUI 40 is provided on a remote computing device 80, as described below.

The remote computing device 80 may include a remote computer or a cloud based operating system. The remote computing device 80 include a processor 82 and a memory 84, wherein the memory 84 is embedded with instructions configured to be executed by the processor 82. In some embodiments, the processes described herein and disclosed in detail in the flowcharts of FIGS. 4 and 5 are performed by the processor 62 onboard the fertigation device 12. In other embodiments, the fertigation device 12 communicates with the remote computing device 80 through a communication port 86 so that the processes described herein and disclosed in detail in the flowcharts of FIGS. 4 and 5 are performed by the processor 82 remotely from the fertigation device 12. In such an embodiment, the processor 62 may act as a backup processor to the processor 82. In some embodiments, the communication port 86 is also in communication with a weather station 88 to provide additional data to the processor 62 and/or the processor 82.

In an exemplary embodiment at least one of a measurement of the nitrogen level of the plant canopy and/or a measurement of the net radiation of the plant canopy is determined based on a measurement of the sensor 30. A flow rate of the fertigation applied to the plant canopy is then determined based on the nitrogen level and/or net radiation of the plant canopy. The control circuitry 60 is operably linked to a regulator, e.g. pump 54, to regulate the flow of the at least one of water and/or water in combination with agro-chemicals. Agro-chemicals may be added to the system 10 through the fertigation control system 50, wherein the fertigation control system 50 is adjusted by the control circuitry 60 in real time.

FIG. 4 illustrates a viewing angle of the at least one sensor 30. In an exemplary embodiment, the sensor 30 is positioned at a height 90 of approximately 20 feet and the nozzle 26 has a spray distance 92 of approximately 15 feet. Accordingly, in the exemplary embodiment, the fertigation device 12 has a spray angle 94 of approximately 48.7 degrees. The at least one sensor has a viewing angle 96 of approximately 17 degrees. Accordingly, the sensor 30 needs to be set at an angle 98 of approximately 57° off nadir to avoid sensing fluid from the nozzle 26. In certain embodiments, the one or more infrared radiometers each have a viewing angle between 10 and 25 degrees, between 14 and 20 degrees, or between 15 and 19 degrees.

Referring now to FIG. 5 a method 200 for controlling a flow rate of the fertigation device 12 is provided. As set forth above, the method 200 may be performed by the processor 62 and/or the processor 82. At block 202, the system 10 calculates a net radiation of the plant canopy. A method 300 for calculating the net radiation is provided in FIG. 6 and performed by the processor 62 and/or the processor 82. At block 302, the system 10 measures an incoming shortwave radiation detected by the sensor 30. At block 304, the system 10 estimates a reflected solar radiation by multiplying an albedo by the incoming shortwave radiation detected by the sensor 30. In some embodiments, the albedo is calculated based on at least one of a solar zenith angle, a location, and an aerial image. At block 306, the reflected solar radiation is subtracted from the incoming shortwave radiation detected by the sensor 30 to calculate a net shortwave radiation.

At block 308, an incoming longwave radiation is calculated by multiplying an emissivity of the air, the Stefan-Boltzmann constant, and a temperature of the air to the fourth power. At block 310, an outgoing longwave radiation is calculated by multiplying an emissivity of the plant canopy, the Stefan-Boltzmann constant, and a temperature of the plant canopy as measured by the sensor to the fourth power. At block 312, the net longwave radiation is calculated by subtracting the outgoing longwave radiation from the incoming longwave radiation. At block 314, the net shortwave radiation is added to the net longwave radiation to determine a net radiation.

Referring back to FIG. 5, at block 204 a sensible heat flux from the plant canopy is calculated. In some embodiments, the sensible heat flux from the plant canopy is calculated by characterizing a surface temperature ramp structure including a ramp amplitude and a ramp duration measured by the sensor 30 using the Van Atta Analysis procedure, as described in Van Atta, C W., 1977, Effect of coherent structures on structure functions of temperature in the atmospheric boundary layer, Arch. Mech., 29:161-171, which is hereby incorporated by reference in its entirety herein. At block 206, data related to a soil heat flux of the plant canopy is received by the system 10. In some embodiments, the data is received from the weather station 88. At block 208, a latent heat flux of the plant canopy is calculated based on the net radiation, the sensible heat flux, and the soil heat flux. In some embodiments, a flow rate of the fluid applied to the plant canopy is adjusted based on the latent heat flux of the plant canopy.

In some embodiments, the system 10 determines a speed of the fertigation device 12 at block 210. For example, the positioning sensor 68 may detect a position of the fertigation device 12. The system 10 may determine the speed of the fertigation device 12 based on a rate of change in the position of the fertigation device over time. At block 212 a flow rate of the fertigation device 12 is adjusted based on the speed of the fertigation device and a condition of the plant canopy, e.g. nitrogen level and/or latent heat flux. A fertigation application depth may be determined based on the speed of the fertigation device and fertigation device parameters, for example, irrigation pump flow rate, time to complete a full irrigation pass over the field, and irrigation depth corresponding to 100% speed of the device 12.

FIG. 7 illustrates a graph 400 showing an amount of fluid application in inches (y-axis 402) by month (x-axis 404). A first line 410 illustrates a wilting point of the plant canopy. A second line 412 illustrates a field capacity of the plant canopy. A third line 414 between the first line 410 and the second line 412 illustrates the minimum allowable water for the plant canopy. The line 416 illustrates the amount of water applied using the system 10 and methods described herein.

FIG. 8 illustrates a graph 450 showing validation of the evapotranspiration calculated using the sensors of the system of FIG. 1. In FIG. 8, evapotranspiration using the approach to calculate sensible heat flux described herein on x-axis 452 is compared to evapotranspiration using sensible heat flux measured by Eddy Covariance (reference standard) on y-axis 454. For both methods, evapotranspiration was calculated by estimating latent heat flux as the residual of the surface energy balance. The latent heat flux was then calculated to a depth (mm).

In general, evapotranspiration is calculated using an energy balance. In one embodiment, the system 10 performs estimations of evapotranspiration every 30 minutes. The surface energy balance equation used by the system 10 for the crop soil surface is written as Rn=H+ΔE+G, where Rn is net radiation, H is sensible heat flux, λE is latent heat (1 is the specific latent heat of evaporation, E is the evaporation rate) flux and G is the ground heat flux. Rn is the absorbed solar and thermal energy from the atmosphere and is balanced by sensible (energy exchange from air movement), latent (energy exchange from transpiration/evaporation), and ground (energy gained or loss during below ground warming or cooling) heat fluxes. Three components of the energy balance are directly measured or modeled by the system 10, where λE is calculated as the residual:

$$λ E = Rn - H - G .$$

Net Radiation is made up of four radiation components: Incoming Shortwave (SWi), Reflected Solar (SWo), Incoming Longwave (LWi), and Outgoing (emitted) Longwave (LWo) radiation. Net radiation can be directly measured used a two component net radiometer (SWnet and LWnet) or a four component net radiometer (SWi, SWo, LWi, and LWo) or can be estimated using a mix of modeled or measured radiation components. The system 10 may use SWi from a nearby weather station 88 or a weather service source. SWo may be estimated by calculating an albedo and multiplying it by SWi. For example, the following equations may be used to calculate net radiation:

$${R}_{net} = {SW}_{net} + {LW}_{net}$$

$${SW}_{net} = {SW}_{i} - {SW}_{o}$$

$${SW}_{i} = direct measurement$$

$${Sw}_{o} = {SW}_{i} \times albedo$$

$${LW}_{net} = {LW}_{i} - {LW}_{o}$$

$${LW}_{i} = {ϵ}_{Sky} σ {{T}_{air}}^{4}$$

$${LW}_{o} = {ϵ}_{Surface} σ {{T}_{surface}}^{4}$$

$$σ = Stefan - Boltzman constant$$

$$ϵ = emissivity$$

$${T}_{air} = air temperature in K$$

$${T}_{surface} = surface temperature in K ( measured by Infrared Radiometer from device )$$

Soil heat flux is directly measured or calculated using one of serval available models that use net radiation and canopy cover/leaf area index as inputs. Sensible heat flux is calculated by characterizing the surface temperature ramp structures that are measured by an infrared thermometer (IRT). Characterization is done using the Van Atta Analysis, as set forth in the equations below:

$$H = ρ {C}_{ρ} \frac{a}{( d + s )}$$

$${C}_{ρ} = specific heat of air$$

$$ρ = air density$$

$$a = average thermal ramp stucture amplitude$$

$$( d + s ) = averagethermal ramp stucture time duration + quiscent period between ramps$$

The system 10 provides an algorithm to detect temporal structures in infrared heat signatures to estimate ET via surface renewal. The system 10 enables the application of surface renewal ET on a moving platform and the ability to develop an as-applied irrigation map. Long term characterization of spatial structure in ET may be provided by the system 10. The system 10 also provides the ability to map soil water holding capacity and control irrigation amount and timing based on stress index.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless cannot be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used, the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles have been presented, they need not be utilized in combination, and many combinations of aspects and principles are possible in light of the various embodiments provided above.

1. A system for automatically determining a fertigation timing or amount in real time based on a plant canopy measurement, the system comprising:
a fertigation device for applying fluid to the plant canopy, the fertigation device capable of movement;
at least two sensors coupled to the fertigation device and configured to measure a condition of the plant canopy, wherein each of the at least two sensors determine a measurement of the temperature of the plant canopy, with at least one sensor measuring the temperature of the plant canopy in the forward direction of movement of the fertigation device, and at least one sensor measuring the temperature of the plant canopy in the rearward direction of movement of the fertigation device; and
control circuitry having a processor and a memory, wherein the memory is embedded with instructions configured to be executed by the processor, wherein the control circuitry is in communication with the sensor and the processor is configured to map the condition of the plant canopy both prior to and following application of the fertigation.

2. The system of claim 1, wherein the fluid comprises at least one of water and water in combination with agro-chemicals, and the control circuitry is operably linked to a regulator that regulates the flow of the at least one of water and water in combination with agro-chemicals.

3. The system of claim 2, wherein the fluid comprises agro-chemicals added to the system through a fertigation control system that is adjusted by the control circuitry in real time, and the fertigation control system includes at least one of a venturi system, a suction injection system, an electric injection pump, a piston-activated pump and a diaphragm activated pump.

4. The system of claim 1, wherein the control circuitry includes a remote computing device.

5. The system of claim 1, wherein the control circuitry is positioned on the fertigation device and coupled to the sensor.

6. The system of claim 1, wherein a measurement of the nitrogen level of the plant canopy is determined based on a measurement of the sensor.

7. The system of claim 1, wherein each sensor is a radiometer that determines a measurement of the temperature of the plant canopy based on a single pixel of the plant canopy, with radiation measured at varying canopy depths.

8. The system of claim 7, wherein each radiometer is mounted on the fertigation device and positioned so that the measured radiation is based upon a single oval or ellipse shaped pixel of the plant canopy.

9. The system of claim 8, wherein the single oval or ellipse shaped pixel is approximately 50 feet in width by about 100 feet in length at the farthest part.

10. The system of claim 7, wherein the radiation measured by the sensor is in the range of 6.5 to 14 microns.

11. The system of claim 7, wherein the canopy depths include the soil as well as the uppermost leaves of the plant canopy.

12. The system of claim 2, wherein the flow rate of the fertigation applied to the plant canopy is determined based on a comparison of the temperature of the plant canopy from at least one forward facing net radiometer and at least one rearward facing net radiometer.

13. The system of claim 1, wherein the processor is configured to:
calculate a sensible heat flux from the plant canopy, receive data related to a soil heat flux of the plant canopy, and calculate a latent heat flux of the plant canopy based on the net radiation, the sensible heat flux, and the soil heat flux.

14. The system of claim 13, wherein a flow rate of the fluid applied to the plant canopy is adjusted based on the latent heat flux of the plant canopy.

15. The system of claim 1, wherein the processor is configured to calculate the net radiation of the plant canopy by adding a net shortwave radiation to a net longwave radiation.

16. The system of claim 15, wherein the processor is configured to calculate the net shortwave radiation by subtracting a reflected solar radiation from an incoming shortwave radiation detected by the sensor, wherein the reflected solar radiation is estimated by multiplying an albedo by the incoming shortwave radiation detected by the sensor.

17. The system of claim 15, wherein the processor is configured to calculate the net longwave radiation by subtracting an outgoing longwave radiation from an incoming longwave radiation, wherein the outgoing longwave radiation is calculated by multiplying an emissivity of the plant canopy, the Stefan-Boltzmann constant, and a temperature of the plant canopy as measured by the sensor to the fourth power, and wherein the incoming longwave radiation is calculated by multiplying an emissivity of the air, the Stefan-Boltzmann constant, and a temperature of the air to the fourth power.

18. The system of claim 16, wherein the albedo is calculated based on at least one of a solar zenith angle, a location, and an aerial image.

19. The system of claim 13, wherein the processor is configured to calculate the sensible heat flux from the plant canopy by characterizing a surface temperature ramp structure including a ramp amplitude and a ramp duration measured by the sensor using the Van Atta Analysis procedure.

20. The system of claim 13, wherein the processor is configured to receive the data related to the soil heat flux of the plant canopy from a weather station.

21. The system of claim 1, wherein the sensor is at least one or more of a radiation sensor, a temperature sensor, a relative humidity sensor, a rain gauge, a nitrogen sensor, a spectral sensor, an accelerometer, an anemometer, a global positioning sensor, and a pressure sensor.

22. The system of claim 1, wherein the fertigation device is at least one of a linear irrigator and a center pivot irrigator.

23. The system of claim 1, wherein the sensor is an infrared radiation measurement device, comprising at least one of a net radiometer, a pyrgeometer, and an infrared radiometric thermometer.

24. The system of claim 1, wherein the processor is further configured to:
determine a speed of the fertigation device, and
adjust a flow rate of the fertigation device based on the speed of the fertigation device and the condition of the plant canopy.

25. The system of claim 24, further comprising a positioning sensor coupled to the fertigation device and configured to detect a position of the fertigation device, wherein the processor determines the speed of the fertigation device based on a rate of change in a position of the fertigation device over time.

26. The system of claim 25, wherein a fertigation application depth is determined based on the speed of the fertigation device and fertigation device parameters.

27. The system of claim 1, wherein the at least two sensors comprise two infrared radiometers positioned on one or more adjustable mounts that permit the radiometers to be remotely adjusted through a graphical user interface.

28. The system of claim 1, further comprising an incoming radiation sensor.
